(19) United States
(12) Patent Application Publication
(10) Pub. No.: US 2025/0130343 A1
(43) Pub. Date: Apr. 24, 2025

(54) FAST Q FILTER ESTIMATION IN ACOUSTIC WAVEFORM INVERSION

(71) Applicant: Halliburton Energy Services, Inc., Houston, TX (US)

(72) Inventors: Xusong WANG, Singapore (SG); Christopher Michael JONES, Houston, TX (US); Xiang WU, Singapore (SG); Jichun SUN, Singapore (SG)

(73) Assignee: Halliburton Energy Services, Inc., Houston, TX (US)

(21) Appl. No.: 18/383,401

(22) Filed: Oct. 24, 2023

Related U.S. Application Data
(60) Provisional application No. 63/463,414, filed on May 2, 2023.

(51) Int. Cl. G01V 1/50

(52) U.S. Cl. CPC G01V 1/50

(57) ABSTRACT

Described herein are systems, apparatuses, processes (also referred to as methods), and computer-readable media (collectively referred to as “systems and techniques”) for improving an accuracy of determinations made using data sensed in a wellbore. Such systems and techniques may use a combination of sampled data and simulated data to generate updated datasets that may be used to make evaluations about how well a casing is cemented to subterranean formations where a wellbore is located.

### CROSS-REFERENCE TO RELATED APPLICATIONS

This application claims benefit of U.S. Provisional Application No. 63/463,414 filed May 2, 2023, which is incorporated herein by reference.

### TECHNICAL FIELD

The present disclosure is generally directed to wellbore sensing systems. More specifically, the present disclosure is directed to improving evaluations made from sensed data.

### BACKGROUND

When managing oil and gas drilling and production environments (e.g., wellbores, etc.) and performing operations in the oil and gas drilling and production environments, it is important to obtain measurements and other sensor data and details regarding Earth formations and conditions in the vicinity of a wellbore. Such data may be used to understand downhole conditions and help manage the wellbore and associated operations. Sensor data can be evaluated to identify the integrity of a wellbore yet often constraints of the wellbore environment limit the accuracy of data sensed by sensors. This means that evaluations performed, for example, by computers may not be as accurate as they potentially could be.

### BRIEF DESCRIPTION OF THE DRAWINGS

In order to describe the manner in which the features and advantages of this disclosure can be obtained, a more particular description is provided with reference to specific implementations thereof which are illustrated in the appended drawings. Understanding that these drawings depict only exemplary implementations of the disclosure and are not therefore to be considered to be limiting of its scope, the principles herein are described and explained with additional specificity and detail through the use of the accompanying drawings in which:

FIG. 1A is a schematic diagram of an example logging while drilling wellbore operating environment, in accordance with various aspects of the subject technology.

FIG. 1B is a schematic diagram of an example downhole environment having tubulars, in accordance with various aspects of the subject technology.

FIG. 2 illustrates a portion of a wellbore casing that has been cemented into a wellbore, in accordance with various aspects of the subject technology.

FIG. 3 illustrates actions that may be performed by a computer model when collected sensed data is evaluated, in accordance with various aspects of the subject technology.

FIG. 4 illustrates waveforms spectrum changes of those waveforms as the change with travel time, in accordance with various aspects of the subject technology.

FIG. 5 illustrates a zero-phase wavelet and minimum phase changes of wavelets, in accordance with various aspects of the subject technology.

FIG. 6 illustrates different wavelet waveforms and their respective phases, in accordance with various aspects of the subject technology.

FIG. 7 illustrates several different sets of curves, where each curve set has two different phase plots, one generated by performing the analytical Q filter time-frequency attenuation equation and another generated from sampled data, in accordance with various aspects of the subject technology.

FIG. 8 illustrates a real acoustic wavelet amplitude spectrum with and without Q absorption, in accordance with various aspects of the subject technology.

FIG. 9 illustrates a workflow that may be performed when a computer executes instructions of a computer model when the computer determines whether a wellbore is properly cemented to a wellbore, in accordance with various aspects of the subject technology.

FIG. 10 illustrates two similar, yet slightly different curves generated by computer models of the present disclosure, in accordance with various aspects of the subject technology.

FIG. 11 illustrates two curves that respectively show an amplitude decay phase rotation with frequency of energy that has been transmitted into a wellbore casing, in accordance with various aspects of the subject technology.

FIG. 12 illustrates an example computing device architecture which can be employed to perform various steps, methods, and techniques disclosed herein.

### DETAILED DESCRIPTION

Various aspects of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the principles disclosed herein. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

It will be appreciated that for simplicity and clarity of illustration, where appropriate, reference numerals have been repeated among the different figures to indicate corresponding or analogous elements. In addition, numerous specific details are set forth in order to provide a thorough understanding of the methods and apparatus described herein. However, it will be understood by those of ordinary skill in the art that the methods and apparatus described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the present disclosure.

Assessments relating to the quality of the construction of a wellbore requires deploying equipment in a wellbore during one or more phases of wellbore development. In instances when a wellbore project is focused on extracting hydrocarbons from the Earth, the phases of such a wellbore project may include a drilling phase, a sleeving phase, a cementing phase, and a production phase. A given type of wellbore project may include additional or different phases, such as a hydraulic fracturing phase or a carbon sequestration phase.

Described herein are systems, apparatuses, processes (also referred to as methods), and computer-readable media (collectively referred to as “systems and techniques”) for improving an accuracy of determinations made using data sensed in a wellbore. Different types of sensing devices may be used to collect data used to identify structures of formations within the Earth and gain insights about the formations and conditions within a wellbore. Examples of such sensing devices include sonic/ultrasonic sensing devices, electromagnetic sensing devices, and nuclear magnetic resonance (NMR) sensing devices. These sensing devices may collect data at virtually any phase of wellbore development. Evaluations performed using this collected data may identify whether a particular wellbore development phase meets quality expectations. For example, sensed data may be evaluated to identify whether the quality of a cementing operation meets wellbore cementing process requirements.

A wellbore casing includes many different segments that are commonly attached to each other by screwing to pieces of pipe together to form a metallic tube that is deployed in the Earth. Once deployed, the casing is commonly cemented in place and the cement is allowed to cure. Ideally, cured cement should uniformly adhere external surfaces of the casing to internal surfaces of a wellbore where the casing is deployed. In practice, such a cementing operation may never be perfect, yet may be adequate to accomplish a task (e.g., hydrocarbon extraction). To determine whether a wellbore has been manufactured to a quality level that is acceptable for a given task, characteristics of the wellbore must meet at least some standard or threshold requirements associated with that given task. For this reason, measurements must be made and data from these measurements must be analyzed such that the characteristics of the wellbore may be quantified.

One technique that may be used to collect data that can be used identify whether a wellbore casing has been cemented into place is to emit acoustic energy from an acoustic transmitter deployed in the wellbore, to receive reflections of that transmitted acoustic energy, and to make evaluations from data associated with the reflected acoustic energy. In general, wellbore casings that are adequately cemented in place will absorb the transmitted acoustic energy more rapidly than wellbore casings that are not adequately cemented in place. For example, a casing that has not been cemented into place will tend to vibrate (ring) longer and louder than a casing that has been cemented into place. One reason for this is that energy transferred into a casing will propagate through the cement and into surrounding formation structures of the wellbore that dissipate the transmitted energy more efficiently than a casing that is not attached to the structures of the wellbore by cement. The casing that has not been cemented into place will have a tendency to vibrate longer because energy will not readily be transferred into the surrounding formation structures of the wellbore.

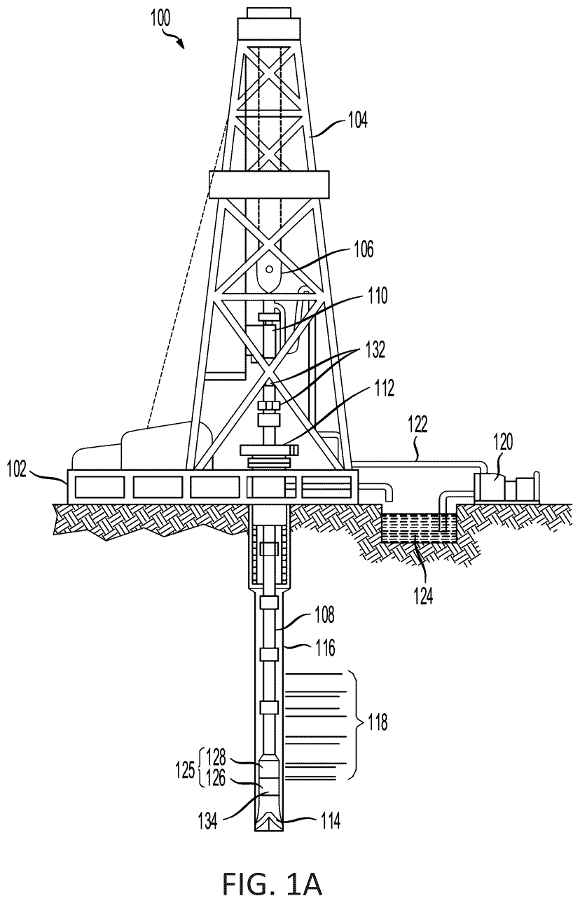

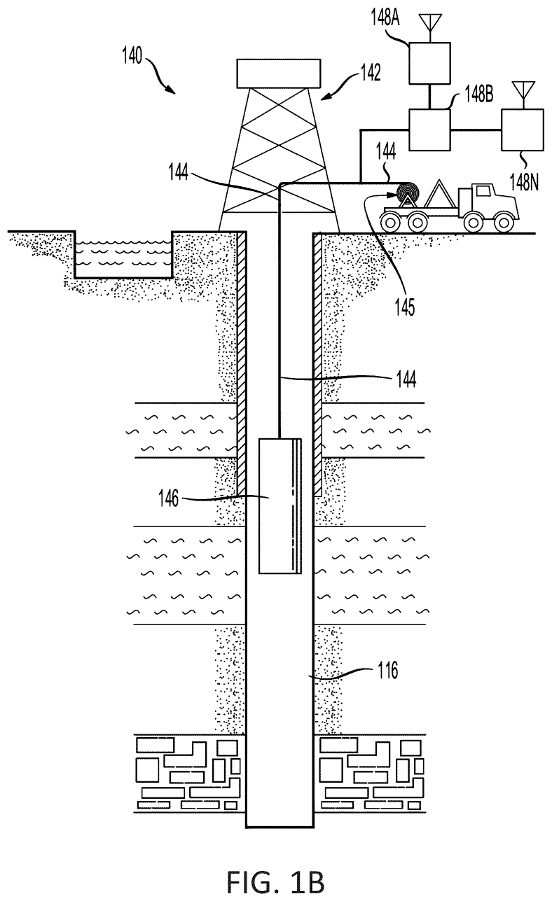

FIG. 1A is a schematic diagram of an example logging while drilling wellbore operating environment, in accordance with various aspects of the subject technology. The drilling arrangement shown in FIG. 1A provides an example of a logging-while-drilling (commonly abbreviated as LWD) configuration in a wellbore drilling scenario 100. The LWD configuration can incorporate sensors (e.g., EM sensors, seismic sensors, gravity sensor, image sensors, etc.) that can acquire formation data, such as characteristics of the formation, components of the formation, etc. For example, the drilling arrangement shown in FIG. 1A can be used to gather formation data through an electromagnetic imager tool (not shown) as part of logging the wellbore using the electromagnetic imager tool. The drilling arrangement of FIG. 1A also exemplifies what is referred to as Measurement While Drilling (commonly abbreviated as MWD) which utilizes sensors to acquire data from which the wellbore's path and position in three-dimensional space can be determined. FIG. 1A shows a drilling platform 102 equipped with a derrick 104 that supports a hoist 106 for raising and lowering a drill string 108. The hoist 106 suspends a top drive 110 suitable for rotating and lowering the drill string 108 through a well head 112. A drill bit 114 can be connected to the lower end of the drill string 108. As the drill bit 114 rotates, it creates a wellbore 116 that passes through various subterranean formations 118. A pump 120 circulates drilling fluid through a supply pipe 122 to top drive 110, down through the interior of drill string 108 and out orifices in drill bit 114 into the wellbore. The drilling fluid returns to the surface via the annulus around drill string 108, and into a retention pit 124. The drilling fluid transports cuttings from the wellbore 116 into the retention pit 124 and the drilling fluid's presence in the annulus aids in maintaining the integrity of the wellbore 116. Various materials can be used for drilling fluid, including oil-based fluids and water-based fluids.

Logging tools 126 can be integrated into the bottom-hole assembly 125 near the drill bit 114. As drill bit 114 extends into the wellbore 116 through the formations 118 and as the drill string 108 is pulled out of the wellbore 116, logging tools 126 collect measurements relating to various formation properties as well as the orientation of the tool and various other drilling conditions. The logging tool 126 can be applicable tools for collecting measurements in a drilling scenario, such as the electromagnetic imager tools described herein. Each of the logging tools 126 may include one or more tool components spaced apart from each other and communicatively coupled by one or more wires and/or other communication arrangement. The logging tools 126 may also include one or more computing devices communicatively coupled with one or more of the tool components. The one or more computing devices may be configured to control or monitor performance of the tool, process logging data, and/or carry out one or more aspects of the methods and processes of the present disclosure.

The bottom-hole assembly 125 may also include a telemetry sub 128 to transfer measurement data to a surface receiver 132 and to receive commands from the surface. In at least some cases, the telemetry sub 128 communicates with a surface receiver 132 by wireless signal transmission (e.g., using mud pulse telemetry, EM telemetry, or acoustic telemetry). In other cases, one or more of the logging tools 126 may communicate with a surface receiver 132 by a wire, such as wired drill pipe. In some instances, the telemetry sub 128 does not communicate with the surface, but rather stores logging data for later retrieval at the surface when the logging assembly is recovered. In at least some cases, one or more of the logging tools 126 may receive electrical power from a wire that extends to the surface, including wires extending through a wired drill pipe. In other cases, power is provided from one or more batteries or via power generated downhole.

Collar 134 is a frequent component of a drill string 108 and generally resembles a very thick-walled cylindrical pipe, typically with threaded ends and a hollow core for the conveyance of drilling fluid. Multiple collars 134 can be included in the drill string 108 and are constructed and intended to be heavy to apply weight on the drill bit 114 to assist the drilling process. Because of the thickness of the collar's wall, pocket-type cutouts or other type recesses can be provided into the collar's wall without negatively impacting the integrity (strength, rigidity and the like) of the collar as a component of the drill string 108.

FIG. 1B is a schematic diagram of an example downhole environment having tubulars, in accordance with various aspects of the subject technology. In this example, an example system 140 is depicted for conducting downhole measurements after at least a portion of a wellbore has been drilled and the drill string removed from the well. An electromagnetic imager tool (not shown) can be operated in the example system 140 shown in FIG. 1B to log the wellbore. A downhole tool is shown having a tool body 146 in order to carry out logging and/or other operations. For example, instead of using the drill string 108 of FIG. 1A to lower the downhole tool, which can contain sensors and/or other instrumentation for detecting and logging nearby characteristics and conditions of the wellbore 116 and surrounding formations, a wireline conveyance 144 can be used. The tool body 146 can be lowered into the wellbore 116 by wireline conveyance 144. The wireline conveyance 144 can be anchored in the drill rig 142 or by a portable means such as a truck 145. The wireline conveyance 144 can include one or more wires, slicklines, cables, and/or the like, as well as tubular conveyances such as coiled tubing, joint tubing, or other tubulars. The downhole tool can include an applicable tool for collecting measurements in a drilling scenario, such as the electromagnetic imager tools described herein.

The illustrated wireline conveyance 144 provides power and support for the tool, as well as enabling communication between data processors 148A-N on the surface. In some examples, the wireline conveyance 144 can include electrical and/or fiber optic cabling for carrying out communications. The wireline conveyance 144 is sufficiently strong and flexible to tether the tool body 146 through the wellbore 116, while also permitting communication through the wireline conveyance 144 to one or more of the processors 148A-N, which can include local and/or remote processors. The processors 148A-N can be integrated as part of an applicable computing system, such as the computing device architectures described herein. Moreover, power can be supplied via the wireline conveyance 144 to meet power requirements of the tool. For slickline or coiled tubing configurations, power can be supplied downhole with a battery or via a downhole generator.

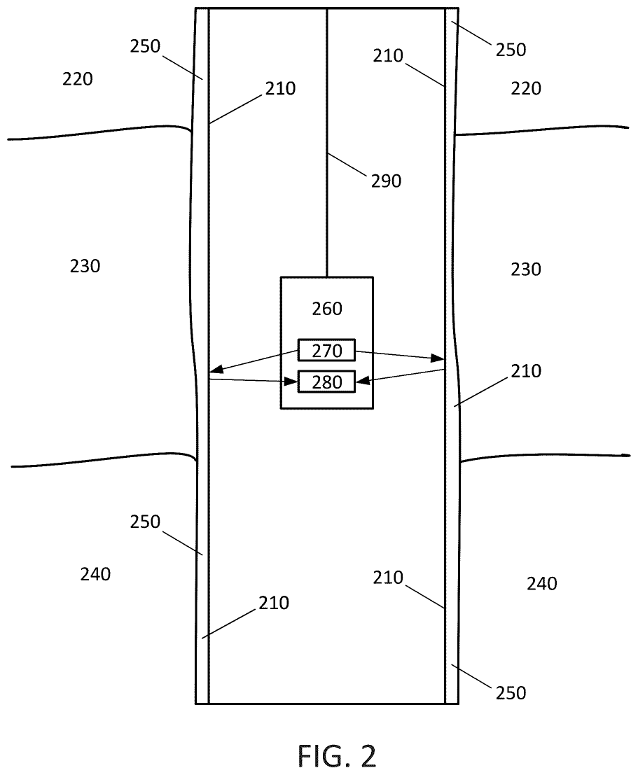

FIG. 2 illustrates a portion of a wellbore casing that has been cemented into a wellbore. FIG. 2 includes casing 210 that crosses through three different subterranean strata (220, 230, and 240) and each of these strata may include different types of materials. For example, strata 220 may include predominantly wet compacted sand, strata 230 may include predominantly sandstone, and strata 240 may include predominantly granite rock. Each of these different strata may also be associated with a porosity, density, and/or permeability or changes in porosity, density, and/or permeability.

Casing 210 may be cemented in place in the wellbore with cement 250. FIG. 2 illustrates different thicknesses of cement located at different parts of the wellbore. While not illustrated in FIG. 2, cement used to attach a casing to subterranean strata may have cracks, holes, or other defects that if too large could impact the robustness of the wellbore. Sensing apparatus 260 may be lowered using line 290 into casing 210 after cement 250 has cured. A transmitter 270 may emit energy toward casing 210 as indicated by the arrowed lines that move from transmitter 270 toward casing 210. A receiver 280 may receive energy that has been reflected off of casing 210 as indicated by the arrowed lines that move from casing 210 to receiver 280. When the energy emitted by transmitter 270 and received by receiver 280 is acoustic (sonic or ultrasonic) energy, patterns of a plot time domain plot of sensed data may be evaluated to identify properties of the wellbore that are characteristic of how well a casing is cemented into a wellbore.

As sensing apparatus 260 is lowered transmitter 270 may transmit energy (e.g., acoustic energy) toward casing 210 and receiver 280 may receive reflections of the transmitted energy as data that can be used to identify how well casing 210 is affixed to the wellbore by cement 250. Data sensed over the length of the wellbore may be used to identify whether the wellbore meets quality rules for being placed into service.

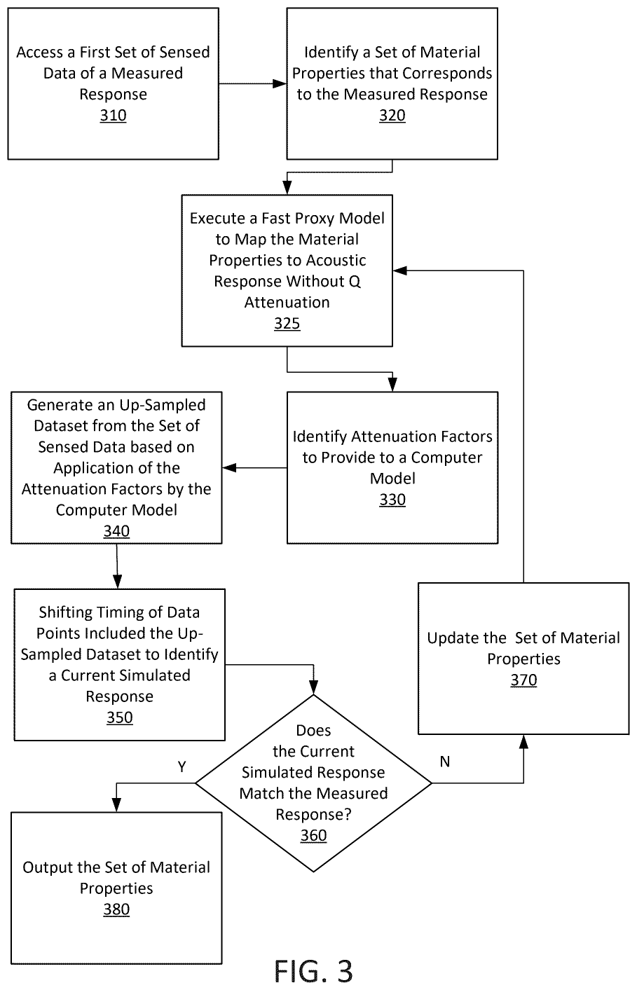

FIG. 3 illustrates actions that may be performed by a computer model when collected sensed data is evaluated. FIG. 3 begins with block 310 where a first set of sensed data of a measured response is accessed. This first set of sensed data may include data that was sensed using sensing apparatus 260 of FIG. 2. This sensed data may be evaluated to identify a waveform in the time domain from which measurements of energy absorption may be identified. This waveform may be consistent with waveforms that are characteristic of one or more different sets of materials. Because of this, first set of sensed data may be evaluated to identify an initial set of material properties at block 320. These material properties may include one or more of a type of material, a porosity, a density, or a permeability. As such, block 320 may identify that the casing is cemented into a formation that includes sand, sandstone, granite, portions of fluid, or other materials. The measured response may also be used to estimate porosity, density, and/or permeability as well as other properties of the wellbore. At block 325 instructions of a fast proxy model may be executed to map the material properties in the set of material properties to acoustic responses without considering Q attenuation affects.

Each of these different types of materials or material properties may be associated with particular attenuation factors that may be provided to a computer model. Because of this, attenuation factors may be identified in block 330 of FIG. 3. Formula 1 is an equation that may be used by the computer model when the computer model generates an up-sampled dataset at block 340 and this up-sampled dataset may correspond to a simulated response.

$${α}_{Q} = exp ( - \frac{ω τ}{2 Q} + iH ( \frac{ω τ}{2 Q} ) ) \qquad Formula 1$$

$$Analytical Q Filter Time - Frequency Attenuation Equation$$

Formula 1 may be referred to as an analytical Q filter time-frequency attenuation equation that may associate amplitude decay with phase change. A time-frequency attenuation measure may be represented by α_{Q} where ω is angular frequency, τ refers to travel time, Q refers to Q factor, and His a Hilbert transform, and i is an imaginary number of phase. The travel time T may equal (2*d/v) where d is a distance that separates a transmitter and receiver of a sensing device from a point of reflection (e.g., a wellbore casing) and where v is an equivalent travel velocity of the transmitted energy. The number 2 indicates a round trip travel distance of energy as the energy travels from the transmitter to the point of reflection (a distance of d) and then from the point of reflection to the receiver (also a distance of d). As such the total distance traveled by the energy is equal to d+d or 2d. The Q factor Q is a ratio between stored energy and energy loss per frequency cycle due to anelasticity of a medium through which an energy wave travels. This anelasticity may be the property of a solid, a fluid, or combination of solids and fluids of the medium that results in a time rate of change of stress in the medium characterized by amplitude loss and potentially phase change of energy that propagates through or into the medium. The function exp(−ωτ/2Q) characterizes amplitude decay of a signal of the energy that moves through the medium as a function of angular frequency, travel time, and Q factor.

At block 340 an up-sampled dataset may be generated from the set of sensed data. Up-sampling is a mathematical process that may smooth resulting data in a manner that makes an image associated with the plotting of data collected using a first sample rate appear to have been collected using a sample rate that is higher than the first sample rate. Generally speaking, an up-sampled representation of a waveform may not appear to include pixelization effects that can affect digitized data. This means that an up-sampled image of a signal may appear sharper than an image plotted using sampled data alone. Systems and techniques of the present disclosure improve upon general up-sampling techniques by assuming that datasets collected in a wellbore that when plotted in the time domain have shapes that correspond to formula 1 (the analytical Q filter time-frequency attenuation equation) even when the collected data does not. Since at least some of the data points included in a waveform of a measured dataset should correspond to data points in an up-sampled dataset, sets of sample data may be updated with results from formula 1 to generate the up-sampled dataset.

Simulations performed by a computer executing instructions of a computer model may result in the computer generating up-sampled datasets and simulated responses. Alternatively or additionally, the computer may use other functions when generating up-sampled datasets and simulated responses. Formula 2 may be referred to as a viscosity attenuation equation αᵥᵢₛ where ω is angular frequency, τ refers to travel time, μ refers to viscosity, ρ refers to material density, and iH is a Hilbert transform.

$${α}_{vis} = exp ( - \frac{2 μ {ω}^{2} τ}{3 {ρν}^{2}} + iH ( \frac{2 {μω}^{2} τ}{3 ρ {v}^{2}} ) ) \qquad Formula 2$$

$$Viscosity Attenuation Equation$$

At block 350, data points included in the up-sampled data set may be shifted in time when a simulated response or simulated response dataset is identified. A plot of the simulated response dataset may be used to generate a curve in the time domain of the simulated response. Determination block 360 may then identify whether the simulated response identified in block 350 matches the measured response. This may include identifying that a current simulated response matches the measured response to a threshold degree based on an average difference between the one or more data points of the simulated response and each of the respective data points being less than a threshold value. When determination block 360 identifies that the current simulated response does not match the measured response to the threshold degree, program flow may move to block 370 where the set of material properties are updated or changed. Program flow may then move back to block 330 where attenuation factors of the updated set of material properties are provided to the computer model such that a new simulation may be performed. Blocks 330, 340, 350, 360, and 370 of FIG. 3 may be performed iteratively until a current simulated response matches, to a threshold degree, the measured response. As such, an initial set of material properties may be identified initially and those material properties may be updated during each iteration such that respective “current” simulated response can be identified.

In an example, a first set of material properties may identify that cement bonding a casing to a portion of a wellbore is consistent with sandstone and a porosity of X. In such an instance, determination block 360 may identify that a simulated response generated from an up-sampled dataset does match the measured response to the threshold degree. At this time, the set of material properties may be updated to indicate the material properties at the location may be consistent with sandstone and a porosity of 0.8X. This may result in a comparison of a current simulated response matching, to the threshold degree, the measured response. Program flow may then move from determination block 360 to block 380 where a current set of material properties are output. In this example, this current set of material properties includes sandstone with the porosity of 0.8X. The current set of material properties, the set of simulated data, and/or a plot of a simulated response may be provided to other processes that make evaluations. These other processes may include making judgements regarding the quality of a wellbore cementing operation, identifying areas where cement bonding does not conform to criteria, and/or that identifies recommendations regarding how a cement bonding defect may be repaired.

Simulation models of the present disclosure may perform evaluations associated with the transmission of energy through solid and/or viscous materials. Such models may be referred to as constant-Q models and these models may assume that an attenuation coefficient is linear with frequency when the Q value is constant for a give travel time. In instances when the Q value is not constant, the attenuation coefficient may not be linear, yet may be assumed to be linear to simplify calculations. A computer executing instructions of these models may identify values of Q attenuation using wave equations (i.e., Q wave equations). These wave equations may include partial differential equations that are referred to as Q wave equations or “visco-acoustic” wave equations and these equations may consist of the set of visco-acoustic wave equations shown below.

$$\frac{1}{{c}^{2}} \frac{{\partial }^{2} p}{\partial {t}^{2}} = {∇}^{2} p + [ {η ( - {∇}^{2} )}^{γ + 1} - {∇}^{2} ] p + τ \frac{\partial }{\partial t} {( - {∇}^{2} )}^{γ + 1 / 2 p} \\ η ( x ) = - {{c}_{0}^{2 γ ( x )}}_{{}_{}}^{} {ω}_{0}^{- 2 γ ( x )} cos ( πγ ( x ) ) , \\ \text{?} ( x ) = - {{c}_{0}^{2 γ ( x ) - 1}}_{{}_{}}^{} {ω}_{0}^{- 2 γ ( x )} sin ( πγ ( x ) ) , \\ {c}^{2} ( x ) = {{c}_{0}^{2} ( x )}_{{}_{}}^{} {cos}^{2} ( πγ ( x ) / 2 ) , \\ γ ( x ) = arctan ( 1 / Q ( x ) ) / π .$$

$$Visco - Acoustic Wave Equations$$

$$\text{?} \text{indicates text missing or illegible when filed}$$

In these visco-acoustic wave equations, t is the travel-time. P(x,t) or the letter p in the equations above is the pressure wavefield. c₀(x) is an acoustic velocity model defined at a refence frequency ω₀. γ(x) defined in equation is a dimensionless parameter that may range from 0 to ½. The function y(x) effects the Q value impact. To solve formulas above, different methods may be used, these methods may include the finite element method (FEM), finite difference method (FDM), or finite volume method (FVM) will be used. The FDM method may be defined on a regular/structured grid. The derivative in a partial differential equation may be approximated by differencing over the grid.

The FEM method may subdivide a large system into smaller, simpler parts that may be referred to as finite elements. A finite element method formulation of a boundary value problem finally results in a system of algebraic equations that may be used when simulating a partial differential equation. This combined with a boundary condition and initial status the partial differential equation may be replaced with an algebraic equation. The method approximates the unknown function of pressure over the time-space domain. The simple equations that model these finite elements may then be assembled into a larger system of equations that model an entire system. The FEM method may then approximate a solution by minimizing an associated error function via the calculus of variations. Due to the huge cell or finite element discretizing of the methods reviewed above, the running speed of producing numerical solutions will tend to be slow. Techniques consistent with the present disclosure reduce the time it takes to generate simulations because they avoid using partial differential equations to generate numerical solutions.

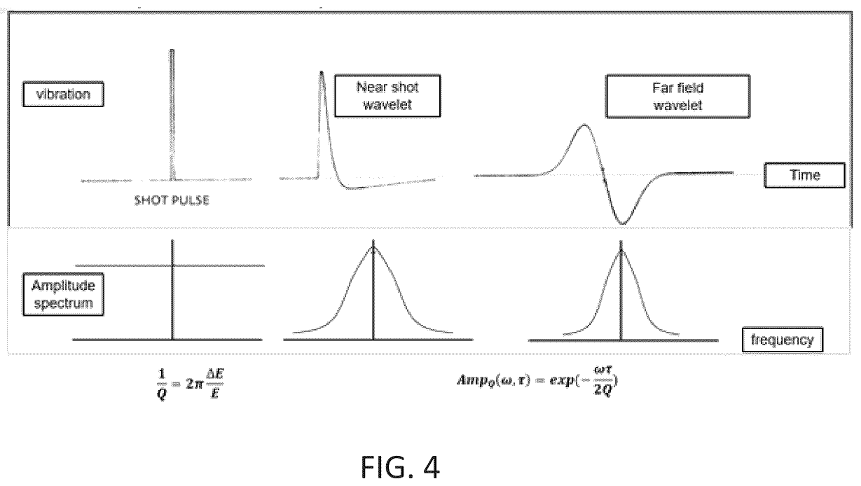

The absorption of energy may be referred to as Q absorption and Q absorption may result in a loss of high frequency signal components as an energy wave migrates through a medium. Amplitude decays when plotted on a dB scale may appear to be linear since these decays may correspond to an exponential function. FIG. 4 illustrates waveforms spectrum changes of those waveforms as the change with travel time. The Q of a medium may affect amplitude and may also affect changes in wavelet phases where relatively higher frequencies will reduce in magnitude faster than relatively lower frequencies.

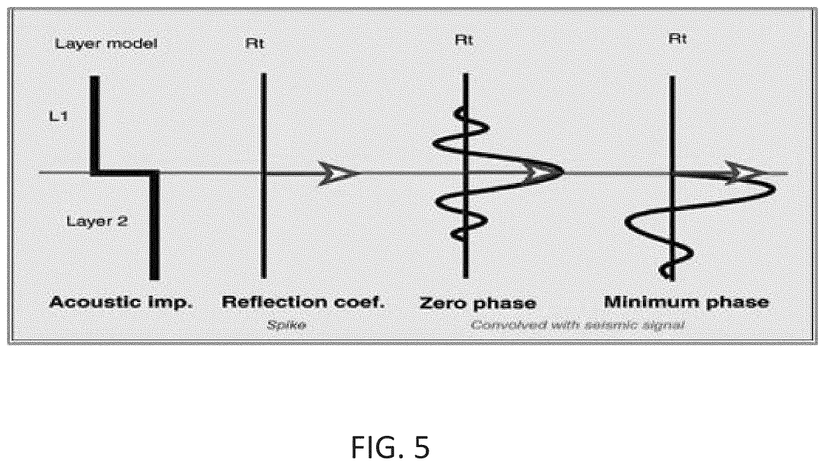

FIG. 5 illustrates a zero-phase wavelet and minimum phase changes of wavelets. FIG. 5 displays the wavelet in real world should be minimum phase since zero phase wavelet is noncausal. Similarly, any physical process, such as Q absorption, scattering, or viscosity attenuation, their filtering effects also follow the minimum phase assumption since there are signals which exist in real world. FIG. 5 shows that when there is an jump in impedance, for example at a location where formation rocks change, the zero phase wavelet of FIG. 5 may be theoretically possible yet because of vibration or other effects, such a zero phase response will not usually or practically be observed. More practically, the minimum phase response will be observed. The wavelets of FIG. 5 may correspond to a wave like oscillation of a transmitted energy pulse used to collect wellbore data.

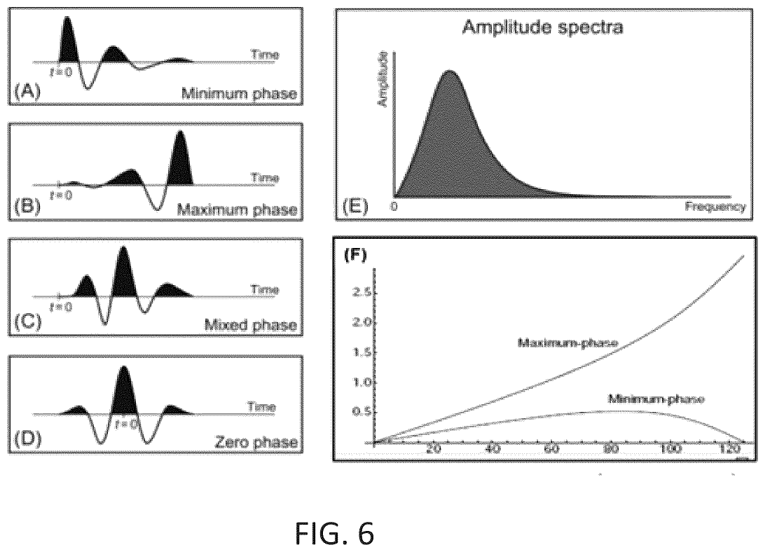

FIG. 6 illustrates different wavelet waveforms and their respective phases. Formula 3 illustrates a relationship between a minimum phase and amplitude spectrum of a wavelet. When a wavelet has a minimum phase, a value of phase may be identified from the amplitude spectrum of the wavelet.

$${θ}_{min} ( ω ) = H \{ - 1 \cdot ln [ Amp ( ω ) ] \} \qquad Formula 3$$

$$Relationship Between a Minimum Phase and Amplitude Spectrum$$

In formula 3, H is the Hilbert Transform, Amp is the amplitude spectrum in frequency domain, θ min is the minimum phase spectrum in frequency domain, and ln is the natural logarithmic operation. This minimum phase is not only valid for Q filter, but also for all physical processes that are causal-a system where an output depends on past and/or current inputs.

The recorded wavelet phase in real-world may be assumed to have the minimum phase due to the causality constraint. Zero phase may only be identifiable by mathematical processing, for example using an autocorrelation or cross-correlation function. Hence in well logging, the Q filter which is caused by Q factor should also have a minimum phase, otherwise the recorded signal will become non-causal.

As illustrated in FIG. 6 and in formula 3, the minimum phase formula is a method for computing a minimum-phase version of a given signal. A minimum-phase signal is a causal signal whose magnitude and phase responses are related by the Kramers-Kronig relations, and which has a minimum phase delay for a given amplitude spectrum response. If combine formula 3 and the Q amplitude formula, of FIG. 4, we can get the analytical Q filter time-frequency attenuation equation (formula 1) discussed above. This analytical Q filter (formula 1) may be theoretically accurate because results derived using formula 1 are not constrained by a sampling rate. Evaluations using digitized data, like data sensed at a wellbore, using this formula may not be accurate when a sensing apparatus has a limited sample rate. Additionally, taking the odd symmetry property into consideration, one can easily conclude that the phase value at the Nyquist frequency of a sampled signal is equal to zero. This implies that the accuracy of using formula 1 in a digitally sampled system will vary with the sampling rate of a digital system. Since constraints associated with the wellbore environment may limit what sampling rate is used, techniques of the present disclosure have been developed to address this shortcoming of a digitally sampled system that often may have a limited sample rate.

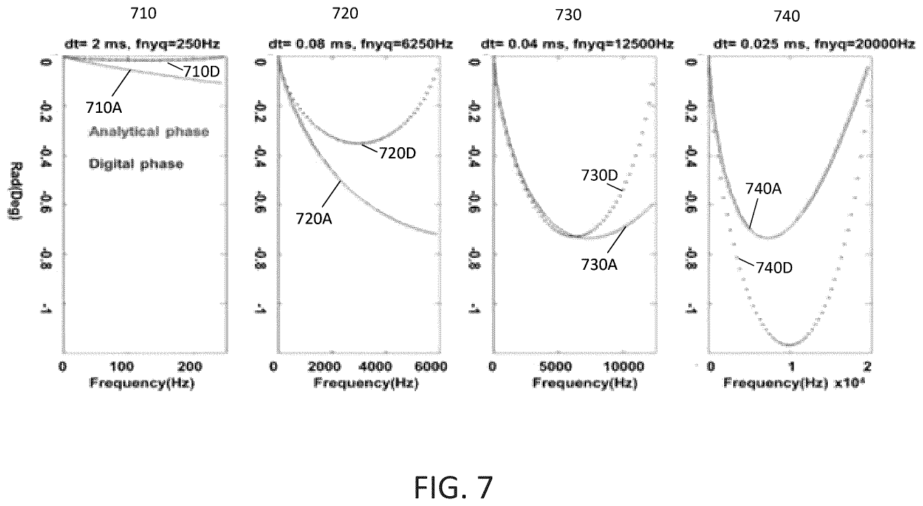

FIG. 7 illustrates several different sets of curves, where each curve set has two different phase plots, one generated by performing the analytical Q filter time-frequency attenuation equation and another generated from sampled data. FIG. 7 includes graphs 710, 720, 730, and 740 and each of these graphs includes a vertical axis of phase change in radian—RAD (Deg)—and a horizontal axis of frequency in Hertz (Hz). Each of these graphs includes an analytically derived phase plot (analytical phase) and a plot of data collected from a real physical system at different a different sampling rate. The analytical phase plots in these respective graphs are plot 710A in graph 720, plot 720A in graph 720, plot 730A in graph 730, and plot 740A in graph 740. Data used to plot these analytical phase plots was derived by applying the analytical Q filter time-frequency attenuation equation according to formula 1 discussed above. As such these analytical phase plots do not include inaccuracy associated with a limited sample rate. The different graphs of FIG. 7 also each include a respective plot of digitally sampled data phase plots are plot 710D of graph 710, plot 720D of graph 720, plot 730 of graph 730, and plot 740 of graph 740.

Graph 710 spans a frequency range from zero Hz to 250 Hz and a sample rate used to collect data used to draw plot 710D was 2 milliseconds (ms). Graph 720 spans a frequency range from zero Hz to 6,250 Hz and a sample rate used to collect data used to draw plot 720D was 0.08 ms. Graph 730 spans a frequency range from zero Hz to 12,500 Hz and a sample rate used to collect data used to draw plot 730D was 0.04 ms. Graph 740 spans a frequency range from zero Hz to 20,000 Hz and a sample rate used to collect data used to draw plot 740D was 0.025 ms. Nyquist frequency for each of the sample rates 2 ms, 0.08 ms, 0.04 ms, and 0.025 ms are respectively 250 Hz; 6,250 Hz; 12,500 Hz; and 20,000 Hz.

Note that the two plots 710A and 710D of graph 710 appear not agree with each other except at frequencies of about 0 to about 10 Hz. The two plots of graph 720 appear to agree with each other at frequencies from 0 Hz to about 500 Hz. The two plots of graph 730 appear to agree with each other at frequencies of 0 Hz to about 2,500 Hz or so. The two plots of graph 740 appear to agree with each other at frequencies of about 0 Hz to about 3,000 Hz or so. While the two curves in each of the plots appear to agree with each other initially, then diverge at some point. This demonstrates that the higher sample rates result in greater agreement or concurrence of an analytical plot with a plot drawn from sampled data, yet not to a degree that might be expected because these plots diverge at frequencies below the Nyquist rate. This may be caused by may be caused by non-linear mapping effects. An extent to which an analytical plot agrees with a plot of sampled data may be quantified by various criteria that may include a same slope and data points of each of the respective plot being within a threshold distance from each other. This threshold distance may be expressed as differences in phase change values that may increase with frequency.

As reviewed above, FIG. 7 shows analytical phase and digital phase spectrum difference of formula 1. Please note that analytical phase is unchanged, however, the digital phase is changing with sampling rate as expected. The phase difference between digital phase and the analytical phase at higher frequencies is very complex, however, it is almost linear at low frequencies. If an amplitude spectrum (signal amplitude) at a high frequency is lower than a threshold frequency, a phase difference at the high frequency will not contribute waveform distortion due to the low high frequency signal amplitude. The linear phase difference at low frequencies will tend to cause time delays that may be observed in time domain. So, when such time delays are ignored for analysis in the time domain, we can use a calculated waveform with Q factor based on formula 1 in acoustic inversion of a computer simulation.

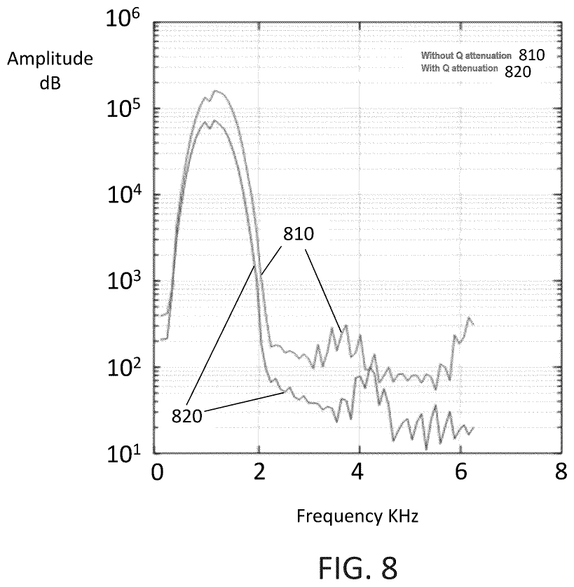

FIG. 8 illustrates a real acoustic wavelet amplitude spectrum with and without Q absorption. Plot 810 may have been plotted based on sensed data collected at a wellbore. This sensed data may have been collected after a pulse of acoustic energy was transmitted toward casing of the wellbore. Plot 810 of FIG. 8 is a plot of measured data without Q attenuation being applied. Plot 820 is a corresponding plot after Q attenuation has been applied. As such, plot 810 may represent a more accurate depiction of the frequency response of ringing of acoustic energy in the wellbore casing because of the up-sampling discussed in respect to FIG. 3.

As discussed above, up-sampling increases an effective sampling rate using mathematical operations such as formula 1, formula 2, or a combination thereof. This may also ensure that amplitudes at relatively higher frequencies (e.g., above 2,300 Hz) are suppressed (reduced in amplitude) as compared to a range of lower frequencies (e.g., 20 Hz to 2,300 Hz). Note that each of plots 810 and 820 track each other between frequencies of 20 Hz to 2,300 Hz. Both of these plots increase in amplitude from 20 Hz to a frequency of 1,500 Hz and then decrease in amplitude from 1,500 Hz to 2,300 Hz. Above 2,300 Hz, the amplitudes of plots 810 and 820 vary up and down, sometimes in opposite directions. Reasons that may explain why plots 810 and 820 vary up and down in different directions is that measured data may be inconsistent with up-sampled data because of non-linear effects at frequencies above 2,300 Hz and because of a signal to noise ratio associated with frequencies above 2,300 Hz.

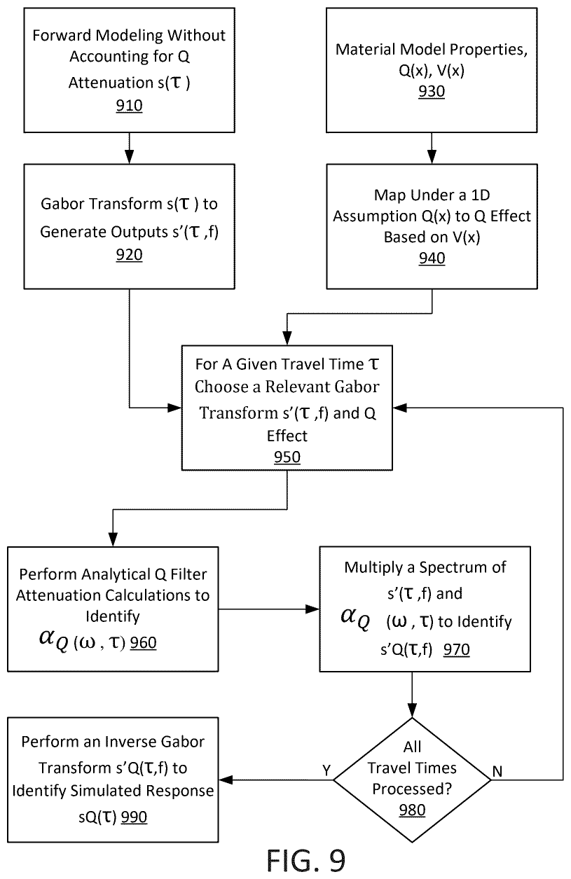

FIG. 9 illustrates a workflow that may be performed when a computer executes instructions of a computer model when the computer determines whether a wellbore is properly cemented to a wellbore. One or more processors of this computer may execute instructions that model a signal s that is transmitted toward a wellbore casing as a function of travel time τ, without accounting for Q attenuation effects at block 910. A Gabor transform or short window Fourier Transform (SWWFFT) may be performed at block 920 to convert time domain function s(τ) to a frequency domain function s′(τ,f). Material properties of a Q(x) function that associates Q with distance and/or properties of a V(x) function that associates viscosity V with distance at block 930. At block 940 a mapping may be made that maps the function Q(x) to Q effect based on the function V(x). Such a mapping may be mapped under an assumption that the mapping should be limited to one dimension (1D). Actions of blocks 910, 920, 930, and 940 may have been performed by one or more processors of the computer using parallel processing techniques.

At block 950, the computer may for a given travel time T choose a relevant Gabor transform and a relevant Q effect. Analytical Q filter attenuation calculations may then be performed to identify α_{Q} or αᵥᵢₛ as a function of angular frequency ω and travel time τ according to formula 1 or 2 discussed above at block 960. At block 970 a spectrum of s′(τ,f) and α_{Q}(ω,τ) may be multiplied to Identify s′Q(τ,f). Determination block 980 may then identify whether all values of travel time have been processed, when no, program flow may move back to block 950. When determination block 980 identifies that all travel times have been processed, an inverse Gabor transform may be performed at block 990 to identify a simulated response sQ(τ).

Once the simulated response is identified at block 990, characteristics of that response may be evaluated to identify whether cement of a wellbore meets requirements. This time response may be evaluated to identify that the reflected signal dampens at a rate defined by a rule. Dampening effects associated with signals transmitted toward a wellbore casing may result in magnitudes and/or timing of reflected signals reducing over time or with each cycle. When amplitude and timing of these dampening effects are less than threshold values of amplitude and timing, cement of the wellbore may allow a wellbore to be placed into service based on a drilling rule. A drilling rule may identify that attenuation effects must corresponds to an exponential function that may vary on materials to which a wellbore casing is cemented to.

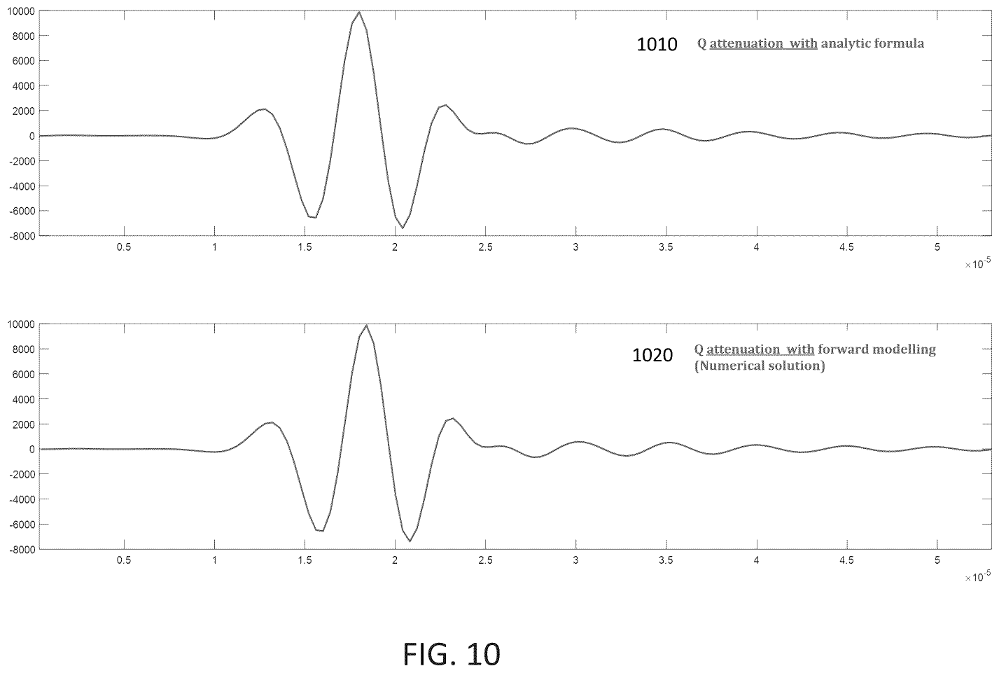

FIG. 10 illustrates two similar, yet slightly different curves generated by computer models of the present disclosure. Curve 1010 is a time domain plot of signal attenuation caused by Q effects of a cemented wellbore casing (amplitude vs time). Curve 1010 may have been generated from sampled data that has been up-sampled using a Q attenuation or viscosity attenuation equation (respectively formula 1 and formula 2 discussed above). Curve 1020 may have been generated using results from a Q attenuation simulation combined with forward modeling based on the application of a visco-acoustic wave equation numerical solution. Even though curves 1010 and 1020 may appear identical, there are some time-shifts between them. These time-shifts may be calibrated before the computer performs waveform inversion.

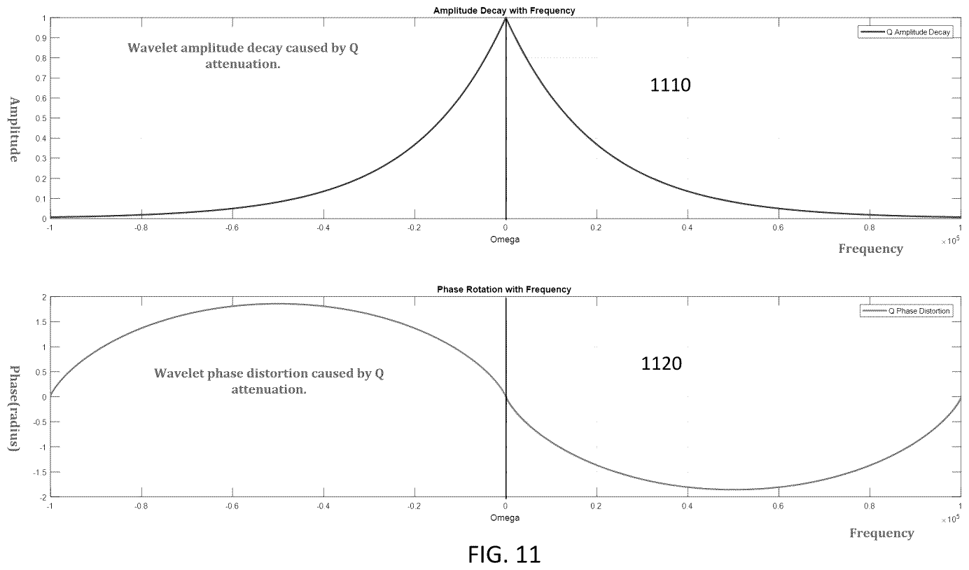

FIG. 11 illustrates two curves that respectively show an amplitude decay phase rotation with frequency of energy that has been transmitted into a wellbore casing. The curves 1110 and 1120 of FIG. 11 include imaginary components at negative frequency and real components at positive frequencies. The peak in the middle of the amplitude decay curve 1110 is located at 0 Hz and amplitudes of curve 1110 reduce exponentially with frequency. This means that energy transmitted into a medium like a cemented wellbore casing, relatively speaking will be higher at lower frequencies and lower at higher frequencies. Curve 1110 and 1120 may be compared to see how amplitude changes and phase rotation change with frequency.

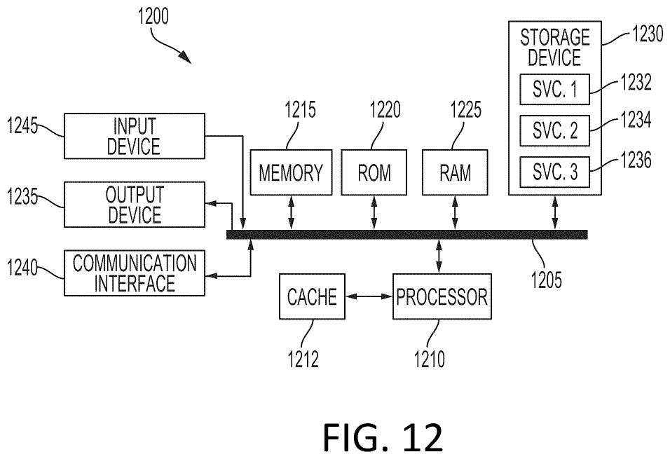

FIG. 12 illustrates an example computing device architecture 1200 which can be employed to perform any of the systems and techniques described herein. In some examples, the computing device architecture can be integrated with the electromagnetic imager tools described herein. Further, the computing device can be configured to implement the techniques of controlling borehole image blending through machine learning described herein.

The components of the computing device architecture 1200 are shown in electrical communication with each other using a connection 1205, such as a bus. The example computing device architecture 1200 includes a processing unit (CPU or processor) 1210 and a computing device connection 1205 that couples various computing device components including the computing device memory 1215, such as read only memory (ROM) 1220 and random access memory (RAM) 1225, to the processor 1210.

The computing device architecture 1200 can include a cache of high-speed memory connected directly with, in close proximity to, or integrated as part of the processor 1210. The computing device architecture 1200 can copy data from the memory 1215 and/or the storage device 1230 to the cache 1212 for quick access by the processor 1210. In this way, the cache can provide a performance boost that avoids processor 1210 delays while waiting for data. These and other modules can control or be configured to control the processor 1210 to perform various actions. Other computing device memory 1215 may be available for use as well. The memory 1215 can include multiple different types of memory with different performance characteristics. The processor 1210 can include any general purpose processor and a hardware or software service, such as service 1 1232, service 2 1234, and service 3 1236 stored in storage device 1230, configured to control the processor 1210 as well as a special-purpose processor where software instructions are incorporated into the processor design. The processor 1210 may be a self-contained system, containing multiple cores or processors, a bus, memory controller, cache, etc. A multi-core processor may be symmetric or asymmetric.

To enable user interaction with the computing device architecture 1200, an input device 1245 can represent any number of input mechanisms, such as a microphone for speech, a touch-sensitive screen for gesture or graphical input, keyboard, mouse, motion input, speech and so forth. An output device 1235 can also be one or more of a number of output mechanisms known to those of skill in the art, such as a display, projector, television, speaker device, etc. In some instances, multimodal computing devices can enable a user to provide multiple types of input to communicate with the computing device architecture 1200. The communications interface 1240 can generally govern and manage the user input and computing device output. There is no restriction on operating on any particular hardware arrangement and therefore the basic features here may easily be substituted for improved hardware or firmware arrangements as they are developed.

Storage device 1230 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1225, read only memory (ROM) 1220, and hybrids thereof. The storage device 1230 can include services 1232, 1234, 1236 for controlling the processor 1210. Other hardware or software modules are contemplated. The storage device 1230 can be connected to the computing device connection 1205. In one aspect, a hardware module that performs a particular function can include the software component stored in a computer-readable medium in connection with the necessary hardware components, such as the processor 1210, connection 1205, output device 1235, and so forth, to carry out the function.

For clarity of explanation, in some instances the present technology may be presented as including individual functional blocks including functional blocks comprising devices, device components, steps or routines in a method implemented in software, or combinations of hardware and software.

In some instances, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples and aspects thereof, but those skilled in the art will recognize that the application is not limited thereto. Thus, while illustrative examples and aspects of the application have been described in detail herein, it is to be understood that the disclosed concepts may be otherwise variously embodied and employed, and that the appended claims are intended to be construed to include such variations, except as limited by the prior art. Various features and aspects of the above-described subject matter may be used individually or jointly. Further, examples and aspects of the systems and techniques described herein can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the method, algorithms, and/or operations described above. The computer-readable data storage medium may form part of a computer program product, which may include packaging materials.

The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

Methods and apparatus of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Such methods may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In the above description, terms such as “upper,” “upward,” “lower,” “downward,” “above,” “below,” “downhole,” “uphole,” “longitudinal,” “lateral,” and the like, as used herein, shall mean in relation to the bottom or furthest extent of the surrounding wellbore even though the wellbore or portions of it may be deviated or horizontal. Correspondingly, the transverse, axial, lateral, longitudinal, radial, etc., orientations shall mean orientations relative to the orientation of the wellbore or tool.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or another word that substantially modifies, such that the component need not be exact. For example, substantially cylindrical means that the object resembles a cylinder, but can have one or more deviations from a true cylinder.

The term “radially” means substantially in a direction along a radius of the object, or having a directional component in a direction along a radius of the object, even if the object is not exactly circular or cylindrical. The term “axially” means substantially along a direction of the axis of the object. If not specified, the term axially is such that it refers to the longer axis of the object.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. The described features and steps are disclosed as possible components of systems and methods within the scope of the appended claims.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Statement 1: A method comprising accessing a set of sensed data representative of a measured response; identifying an initial set of material properties that correspond to the measured response based on a mapping that maps the measured response to one or more properties of the initial set of material properties; identifying factors of an attenuation equation that corresponds to a current set of material properties, wherein the current set of material properties includes the one or more properties of the initial set of material properties; generating an up-sample dataset from the set of sensed data based on application of the factors of the attenuation equation; shifting timing of one or more data points of a simulated response to correspond to respective data points of the set of sensed data to identify a current simulated response; and identifying that the current simulated response matches the measured response.

Statement 2: The method according to Statement 1, wherein the identification that the current simulated response matches the measured response to a threshold degree is based on an average difference between the one or more data points of the simulated response and each of the respective data points being less than a threshold value.

Statement 3: The method according to Statement 1 or Statement 2, wherein the initial set of material properties match the current set of material properties.

Statement 4: The method according to any one of the preceding Statements 1-3, further comprising identifying an initial set of factors of the attenuation equation that correspond to an initial set of material properties that include the one or more properties of the initial set of material properties; generating an initial up-sample dataset from the set of sensed data based on application of the initial set of factors of the attenuation equation; shifting timing of one or more data points of the initial up-sample dataset to correspond to the respective data points of the set of sensed data to identify an initial simulated response; and identifying that the initial simulated response does not match the measured response to the threshold degree.

Statement 5: The method according to Statement 4, further comprising updating the initial set of material properties based on the identification that the initial simulated response does not match the measured response.

Statement 6: The method according to Statement 5, wherein the updated initial set of material properties matches the current set of material properties.

Statement 7: The method according to any one of the preceding Statements 1-6, wherein the attenuation equation models attenuation of a sound wave through a medium.

Statement 8: The method according to Statement 7, wherein the medium includes at least one of solid materials and a fluid.

Statement 9: A non-transitory computer-readable storage medium having embodied thereon instructions executable by one or more processors to perform a method of accessing a set of sensed data representative of a measured response; identifying an initial set of material properties that correspond to the measured response based on a mapping that maps the measured response to one or more properties of the initial set of material properties; identifying factors of an attenuation equation that corresponds to a current set of material properties, wherein the current set of material properties includes the one or more properties of the initial set of material properties; generating an up-sample dataset from the set of sensed data based on application of the factors of the attenuation equation; shifting timing of one or more data points of a simulated response to correspond to respective data points of the set of sensed data to identify a current simulated response; and identifying that the current simulated response matches the measured response.

Statement 10: The non-transitory computer-readable storage medium of Statement 9, wherein the identification that the current simulated response matches the measured response to a threshold degree is based on an average difference between the one or more data points of the simulated response and each of the respective data points being less than a threshold value.

Statement 11: The non-transitory computer-readable storage medium of Statement 9 or Statement 10, wherein the initial set of material properties match the current set of material properties.

Statement 12: The non-transitory computer-readable storage medium of any one of the preceding Statements 9-11, wherein the one or more processors execute the instructions to identify an initial set of factors of the attenuation equation that correspond to an initial set of material properties that include the one or more properties of the initial set of material properties; generate an initial up-sample dataset from the set of sensed data based on application of the initial set of factors of the attenuation equation; shift timing of one or more data points of the initial up-sample dataset to correspond to the respective data points of the set of sensed data to identify an initial simulated response; and identify that the initial simulated response does not match the measured response to the threshold degree.

Statement 13: The non-transitory computer-readable storage medium of Statement 12, wherein the one or more processors execute the instructions to update the initial set of material properties based on the identification that the initial simulated response does not match the measured response.

Statement 14: The non-transitory computer-readable storage medium of Statement 13, wherein the updated initial set of material properties matches the current set of material properties.

Statement 15: The non-transitory computer-readable storage medium of any one of the preceding Statements 9-14, wherein the attenuation equation models attenuation of a sound wave through a medium.

Statement 16: The non-transitory computer-readable storage medium of Statement 15, wherein the medium includes at least one of solid materials and a fluid.

Statement 17: An apparatus comprising a memory; and one or more processors that execute instructions out of the memory to: access a set of sensed data representative of a measured response; identify an initial set of material properties that correspond to the measured response based on a mapping that maps the measured response to one or more properties of the initial set of material properties; identify factors of an attenuation equation that corresponds to a current set of material properties, wherein the current set of material properties includes the one or more properties of the initial set of material properties; generate an up-sample dataset from the set of sensed data based on application of the factors of the attenuation equation; shift timing of one or more data points of a simulated response to correspond to respective data points of the set of sensed data to identify a current simulated response; and identify that the current simulated response matches the measured response.

Statement 18: The apparatus of Statement 17, wherein the identification that the current simulated response matches the measured response to a threshold degree is based on an average difference between the one or more data points of the simulated response and each of the respective data points being less than a threshold value.

Statement 19: The apparatus of Statement 17 or Statement 18, wherein the initial set of material properties match the current set of material properties.

Statement 20: The apparatus of any of the preceding Statements 17-19, wherein the one or more processors execute the instructions to identify an initial set of factors of the attenuation equation that correspond to an initial set of material properties that include the one or more properties of the initial set of material properties; generate an initial up-sample dataset from the set of sensed data based on application of the initial set of factors of the attenuation equation; shift timing of one or more data points of the initial up-sample dataset to correspond to the respective data points of the set of sensed data to identify an initial simulated response; and identify that the initial simulated response does not match the measured response to the threshold degree.

What is claimed is:

1. A method comprising:
accessing a set of sensed data representative of a measured response;
identifying an initial set of material properties that correspond to the measured response based on a mapping that maps the measured response to one or more properties of the initial set of material properties;
identifying factors of an attenuation equation that corresponds to a current set of material properties, wherein the current set of material properties includes the one or more properties of the initial set of material properties;
generating an up-sample dataset from the set of sensed data based on application of the factors of the attenuation equation;
shifting timing of one or more data points of a simulated response to correspond to respective data points of the set of sensed data to identify a current simulated response; and
identifying that the current simulated response matches the measured response.

2. The method of claim 1, wherein the identification that the current simulated response matches the measured response to a threshold degree is based on an average difference between the one or more data points of the simulated response and each of the respective data points being less than a threshold value.

3. The method of claim 1, wherein the initial set of material properties match the current set of material properties.

4. The method of claim 1, further comprising:
identifying an initial set of factors of the attenuation equation that correspond to an initial set of material properties that include the one or more properties of the initial set of material properties;
generating an initial up-sample dataset from the set of sensed data based on application of the initial set of factors of the attenuation equation;
shifting timing of one or more data points of the initial up-sample dataset to correspond to the respective data points of the set of sensed data to identify an initial simulated response; and
identifying that the initial simulated response does not match the measured response to a threshold degree.

5. The method of claim 4, further comprising:
updating the initial set of material properties based on the identification that the initial simulated response does not match the measured response.

6. The method of claim 5, wherein the updated initial set of material properties matches the current set of material properties.

7. The method of claim 1, wherein the attenuation equation models attenuation of a sound wave through a medium.

8. The method of claim 7, wherein the medium includes at least one of solid materials and a fluid.

9. A non-transitory computer-readable storage medium having embodied thereon instructions executable by one or more processors to perform a method of:
accessing a set of sensed data representative of a measured response;
identifying an initial set of material properties that correspond to the measured response based on a mapping that maps the measured response to one or more properties of the initial set of material properties;
identifying factors of an attenuation equation that corresponds to a current set of material properties, wherein the current set of material properties includes the one or more properties of the initial set of material properties;
generating an up-sample dataset from the set of sensed data based on application of the factors of the attenuation equation;
shifting timing of one or more data points of a simulated response to correspond to respective data points of the set of sensed data to identify a current simulated response; and
identifying that the current simulated response matches the measured response.

10. The non-transitory computer-readable storage medium of claim 9, wherein the identification that the current simulated response matches the measured response to a threshold degree is based on an average difference between the one or more data points of the simulated response and each of the respective data points being less than a threshold value.

11. The non-transitory computer-readable storage medium of claim 9, wherein the initial set of material properties match the current set of material properties.

12. The non-transitory computer-readable storage medium of claim 9, wherein the one or more processors execute the instructions to:
identify an initial set of factors of the attenuation equation that correspond to an initial set of material properties that include the one or more properties of the initial set of material properties;
generate an initial up-sample dataset from the set of sensed data based on application of the initial set of factors of the attenuation equation;
shift timing of one or more data points of the initial up-sample dataset to correspond to the respective data points of the set of sensed data to identify an initial simulated response; and
identify that the initial simulated response does not match the measured response to a threshold degree.

13. The non-transitory computer-readable storage medium of claim 12, wherein the one or more processors execute the instructions to:
update the initial set of material properties based on the identification that the initial simulated response does not match the measured response.

14. The non-transitory computer-readable storage medium of claim 13, wherein the updated initial set of material properties matches the current set of material properties.

15. The non-transitory computer-readable storage medium of claim 9, wherein the attenuation equation models attenuation of a sound wave through a medium.

16. The non-transitory computer-readable storage medium of claim 15, wherein the medium includes at least one of solid materials and a fluid.

17. An apparatus comprising:
a memory; and
one or more processors that execute instructions out of the memory to:
access a set of sensed data representative of a measured response;
identify an initial set of material properties that correspond to the measured response based on a mapping that maps the measured response to one or more properties of the initial set of material properties;
identify factors of an attenuation equation that corresponds to a current set of material properties, wherein the current set of material properties includes the one or more properties of the initial set of material properties;
generate an up-sample dataset from the set of sensed data based on application of the factors of the attenuation equation;
shift timing of one or more data points of a simulated response to correspond to respective data points of the set of sensed data to identify a current simulated response; and
identify that the current simulated response matches the measured response.

18. The apparatus of claim 17, wherein the identification that the current simulated response matches the measured response to a threshold degree is based on an average difference between the one or more data points of the simulated response and each of the respective data points being less than a threshold value.

19. The apparatus of claim 17, wherein the initial set of material properties match the current set of material properties.

20. The apparatus of claim 17, wherein the one or more processors execute the instructions to:
identify an initial set of factors of the attenuation equation that correspond to an initial set of material properties that include the one or more properties of the initial set of material properties;
generate an initial up-sample dataset from the set of sensed data based on application of the initial set of factors of the attenuation equation;
shift timing of one or more data points of the initial up-sample dataset to correspond to the respective data points of the set of sensed data to identify an initial simulated response; and
identify that the initial simulated response does not match the measured response to a threshold degree.
